(19) United States
(12) Patent Application Publication
(10) Pub. No.: US 2015/0246660 A1
(43) Pub. Date: Sep. 3, 2015

(54) WIPER FOR CLEANING AN EXPOSED SURFACE OF AN OPTICAL ELEMENT

(71) Applicant: ELECTRO MECHANICAL SYSTEMS LIMITED, Parkstone, Poole, Dorset (GB)

(72) Inventors: Martin Russell Seedall, Swanage (GB); Ian Williamson, Weymouth (GB)

(21) Appl. No.: 14/430,780

(22) PCT Filed: Sep. 23, 2013
(86) PCT No.: PCT/GB2013/052483

§ 371 Date: Mar. 24, 2015

(30) Foreign Application Priority Data
Sep. 24, 2012 (GB) 1217007.2

(51) Int. Cl. B60S 1/56; G02B 7/02; B60S 1/22; B60S 1/44; G02B 27/00

(52) U.S. Cl. CPC B60S 1/56; B60S 1/44; G02B 27/0006; B60S 1/22; G02B 7/023

(57) ABSTRACT

There is disclosed apparatus (10) for cleaning an exposed surface (11) of an optical element (12), such as the exposed optical surface of a wide angle lens installed on a vehicle. The apparatus includes a collar (30) arranged to be disposed circumferentially around, and to rotate around, an axis (16) of the optical element which the apparatus is arranged to clean, and a wiper arm (20) coupled to the collar so as to rotationally clean the exposed surface as the collar rotates.

The present invention relates to apparatus and methods for cleaning or wiping a surface, such as an exposed transparent surface of an optical element. For example, the optical element may be a wide angle lens having a convex exposed front surface, and the invention may be applied in automotive, security, industrial and other areas where automatic or motorised cleaning is desirable.

### INTRODUCTION

Various situations arise in which the exposed surface of an optical element such as a lens for a camera or a lamp may require cleaning in an automated manner. Examples include the cleaning of camera lenses in security, automotive, medical, industrial process and other areas of application. It is of course desirable for mechanisms arranged to carry out such automated cleaning to be robust and reliable over a long period. When the optical element is substantially flat a conventional wiper blade similar to those used on vehicle windscreens may be used, although due to the radial movement, cleaning of substantially the whole of the optical element will be difficult or impossible for most shapes of optical element. Furthermore, it may be difficult to design a robust and reliable wiper of this type for smaller optical elements, and for optical elements having an exposed surface with a significant degree of curvature which tends to interfere with radial motion of a wiper arm.

The invention seeks to address these and other limitations of the related prior art.

### SUMMARY OF INVENTION

The invention provides methods and apparatus for cleaning an exposed surface such as an exposed surface of an optical element in which a wiper arm disposed generally radially (or in some embodiments, more specifically, generally diametrically) on the exposed surface is circumferentially rotated. This can be achieved by moving an end of the wiper arm circumferentially around the outside of the portion of the optical element to be cleaned while retaining the wiper arm in a generally radial or diametrical deployed or active configuration. Preferably, the wiper arm is moveable to a stowed position, which does not obscure the cleaned portion of the optical element, after cleaning has taken place.

The exposed surface may, in particular, be a convex curved surface such as a spherically or other rotationally symmetric curved surface with an apex in a central region of the portion of the optical element to be cleaned, or a correspondingly concave surface. Typically, the exposed surface may be curved so as to be rotationally symmetric about a central point or region such as the apex mentioned above.

The exposed surface may have a circular perimeter. The exposed surface may be transparent or translucent, although the invention may also be used if desired to clean opaque surfaces.

More particularly, the optical element may be a camera lens, such as a wide angle lens. The wide angle lens, or other optical element may be used, for example, on a vehicle such as a road vehicle. However, the optical element may be some other type of lens, or a window of some sort, for example a window used to protect a lens or some other apparatus.

In particular, to clean the exposed surface, the invention provides an apparatus comprising: a collar arranged to be disposed circumferentially around, and to rotate around an optical axis of the optical element which the apparatus is arranged to clean; and a wiper arm coupled to the collar so as to rotationally wipe the exposed surface of the optical element as the collar rotates. The collar may be disposed around the optical element, or the optical element may be displaced axially from the collar such that the collar rotates around an optical axis of the optical element.

The wiper arm may be arranged to move, relative to the collar, between a stowed position in which cleaning does not take place, and a deployed or active position in which the exposed surface of the optical element may be cleaned by the wiper arm. Typically, when in the stowed position the wiper arm will not obscure the optical element, or at least will not obscure a portion of the optical element which is cleaned by the wiper arm.

The wiper arm may be rotationally coupled to the collar for rotational movement between the stowed and active positions across the exposed surface. The wiper arm may also be coupled to the collar so as to move axially relative to the optical element between the stowed and active positions, for example to ensure that the wiper arm is in an optimal position to clean the exposed surface. In particular, rotation of the collar around the optical axis may be used to drive the wiper arm between the stowed and active positions, although other mechanisms could be used. Alternatively or additionally, an axial drive may be used to move the optical element axially, as discussed further below, to bring the optical element into an optimal or suitable position for cleaning by the wiper arm.

The apparatus may further comprise a cam track, wherein the wiper arm is coupled to or provided with a cam follower arranged to follow the cam track as the collar rotates so as to move the wiper arm between the stowed and active positions, and to guide the wiper arm through the rotational cleaning of the exposed surface. To this end, the cam track may comprise a first portion which drives the wiper arm between the stowed and active positions, and a second portion which retains the wiper arm in the active position for wiping the exposed surface as the collar rotates.

The cam track may form a continuous loop. Such a loop may be arranged such that on rotation in a single direction of the collar the wiper arm moves from the stowed position to the active position, wipes the exposed surface, and returns from the active position to the stowed position. Other arrangements, for example in which the collar rotates in both directions, are also possible.

The collar may be disposed adjacent to and arranged to rotate relative to a chassis which is coaxial with the collar. The cam track may then be comprised in the chassis, for example as a groove in a surface of the chassis facing the collar.

The apparatus may further comprise an annular cover disposed in front of the collar. The annular cover may be sprung so as to bias the cam follower towards the cam track. For example, one end of the annular cover may be fixed relative to the collar, and the other end of the annular cover may be urged away from the collar by the axial movement of the wiper arm from the stowed to the active position. The annular cover could be made, for example, from a single piece of a springy material such as stainless steel.

In other embodiments the wiper arm may be rotationally mounted between the chassis and the collar. A distal portion of the wiper arm, for example a tip of the wiper arm may then be retained between the chassis and the collar, or within a groove of the collar, to assist in urging or retaining the wiper arm against the exposed optical surface during the wiping process. The tip may be retained in this way when the wiper arm is in the active position. Optionally, the tip may also be retained between the chassis and the collar, or within a groove of the collar, when the wiper arm is in the stowed position, and optionally also when moving between the stowed and active positions.

The apparatus may further comprise a motor arranged to rotate the collar around the optical element, thereby driving motion of the wiper arm between the stowed and active positions and driving the rotational cleaning movement of the wiper arm.

The wiper arm may comprise a wiper blade arranged to contact the exposed surface, wherein the wiper blade is formed from a flexible material such as an elastomer. Whether a separate material is used for a wiper blade or not, the wiper arm is preferably shaped to contact and clean the exposed surface as the wiper arm rotates during the cleaning action.

The apparatus may comprise an axial drive, for example driven by a motor such as an electrical motor, arranged to retract the optical element and the exposed optical surface, for example from the position in which the optical surface is positioned for use. This backwards movement retraction, and corresponding forwards movement extension along the optical axis can be used for various purposes, for example to retract the optical element to a position suitable for cleaning by the wiper arm, for protection for example from environmental agents such as dirt, water or ice, for security, to provide an axial movement during wiping to improve the cleaning process, and/or for other purposes.

For example, if the exposed surface is located for use in front of the collar for use of the optical element (in a deployed position) then the axial drive may be arranged to retract the optical element and the exposed surface towards the collar for the rotational cleaning of the exposed surface of the optical element as the collar rotates, and to axially extend the optical element forwards again to the deployed position after cleaning.

More generally, the invention may provide apparatus for moving and optionally for cleaning an exposed optical surface of an optical element, comprising: an axial drive arranged to retract the exposed surface towards the apparatus to a retracted position (which may be a cleaning position) and to extend the exposed surface away from the apparatus to a deployed position; and a wiper arm arranged to rotationally clean the exposed surface when in the retracted position, and such apparatus may comprise other apparatus aspects as set out above. In order to effect the axial drive, the apparatus may further comprise an axial drive motor arranged to drive the exposed optical surface between the deployed and retracted positions.

In other embodiments, the axial drive may be effected using a cam arranged to co-rotate with the wiper arm, the cam being provided with a recess arranged to urge axial retraction of the optical element before cleaning, and to allow forwards axial extension of the optical element after cleaning. The cam may, for example, be provided by a backward facing rim of a collar such as the collar already discussed above for driving the wiper arm. The rim may thereby act as a circular cam to control axial movement of the camera, which may for example be urged forward against the cam by a spring.

The invention also provides methods corresponding to the above apparatus, for example a method of cleaning an exposed convex surface of an optical element comprising: disposing a wiper arm generally or approximately or substantially radially (which includes the option of disposing the arm generally or approximately or substantially diametrically) on the exposed surface; and rotating at least one circumferential end of the wiper arm around the outside of the exposed surface, for example all the way around the outside of the exposed surface.

Of course, the wiper arm need not be disposed along an exact radius or diameter of the exposed surface, but should extend generally from a periphery into a central region of the exposed surface to provide adequate cleaning of the exposed surface when rotated, and the terms radially and diametrically should be understood in this manner. Typically, the rotation of the wiper arm around the exposed optical surface may include a full rotation all the way around the outside surface, or at least substantially so, and subsequent rotations may be in the same direction if required. However, other rotational options may be used.

The method may further comprise, for example, rotating the wiper arm to a circumferential stowed position after cleaning the exposed convex surface, in which the wiper arm does not obscure the optical element.

### BRIEF DESCRIPTION OF THE DRAWINGS

Embodiments of the invention will now be described, by way of example only, with reference to the accompanying drawings of which:

FIG. 1 shows in perspective view apparatus for cleaning an exposed surface of an optical element. The optical element is not shown in this figure, but may be disposed within the cylindrical aperture through which an optical axis is shown to pass;

FIG. 2 shows the apparatus of FIG. 1, in which the wiper arm is in an active position, and additionally showing the optical element to be cleaned, with solid arrows showing the rotational direction of the wiper arm and adjacent annular cover;

FIG. 3 is a perspective view of the apparatus without the optical element, in which the wiper arm is moving between a stowed and an active position;

FIG. 4 shows the wiper arm, the chassis, and interaction between the cam follower of the wiper arm and the cam track of the chassis;

FIG. 5 is a cut-away perspective view of the wiper arm, collar, chassis and motor with the wiper arm part way between the stowed and active positions;

FIG. 6 shows the wiper arm, collar and motor with the wiper arm in the active position;

FIG. 7 is a cross section through the apparatus and an optical element deployed as part of a camera;

FIG. 8 shows how the optical element may be deployed in a position such that the exposed surface is in front of the collar, and how the optical element may be retracted using an axial drive for cleaning of the exposed surface, after which the optical element may be returned using the axial drive to the deployed position;

FIG. 9 shows a particular embodiment of the axial drive using a backward facing rim of the collar as a cylindrical cam to urge a camera assembly against a spring and allow forward extension of the camera assembly into the collar as the wiper arm moves into the stowed position;

FIG. 10 shows some components of FIG. 9 with the camera assembly, provided with a triangular cam follower to engage the rim of the collar, in place;

FIG. 11 is a perspective cut away view of an alternative arrangement of the chassis, collar and wiper arm;

FIG. 12 shows the cam track, wiper arm and motorized driving mechanisms for the arrangement of FIG. 11;

FIG. 13 shows the arrangement of FIGS. 11 and 12 with the collar in place;

FIG. 14 shows details of an axial drive which may be used with the arrangement of FIGS. 1 to 8 or 11 to 13;

FIG. 15 shows the arrangement of FIGS. 11 to 14 with a camera assembly installed and the exposed optical surface in an extended position for use; and

FIG. 16 shows the arrangement of FIG. 15 with the camera assembly and exposed optical surface retracted and in the process of being cleaned by the wiper arm.

### DETAILED DESCRIPTION OF EMBODIMENTS

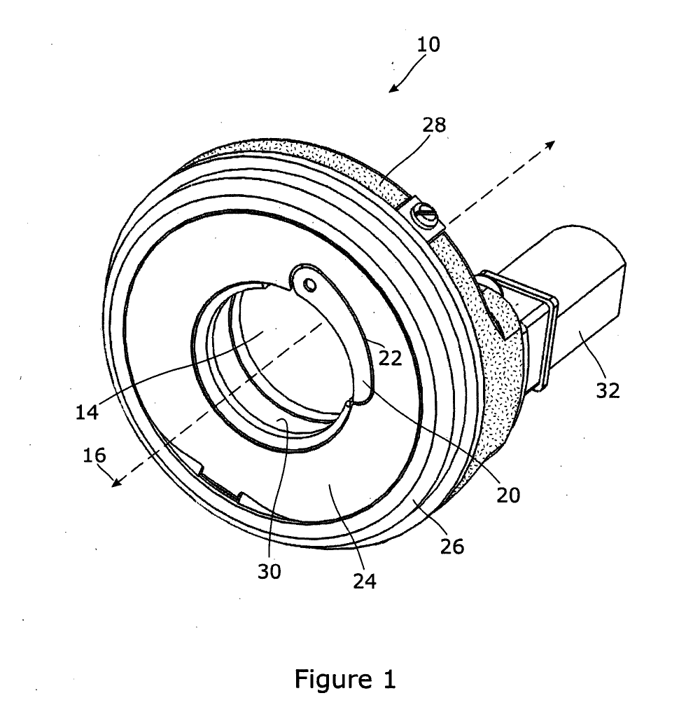

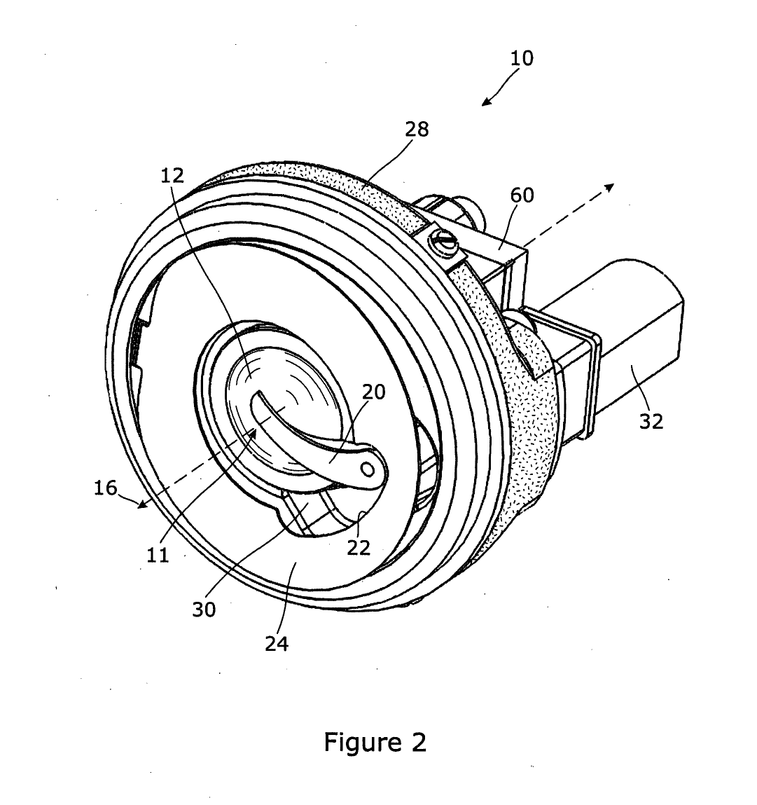

Referring to FIG. 1, there is shown apparatus 10 for cleaning an exposed surface of an optical element, or some other suitable exposed surface. The apparatus includes an aperture 14, which in FIG. 1 is essentially cylindrical, for accepting the optical element and/or components on which the optical element is mounted. For clarity, the optical element is not shown in this figure, but is shown in FIG. 2, and may be for example a wide angle camera lens, an optical element with a convex exposed surface, or similar. The optical element typically has an optical axis 16 which also passes through a central part of the aperture 14.

The apparatus comprises a wiper arm 20 which in FIG. 1 is shown in a stowed position, in which it does not obscure the exposed surface of the optical element. The wiper arm 20 is coupled to a collar 30 which defines at least some of the aperture 14. The wiper arm in the stowed position sits in a correspondingly shaped cut out 22 of an annular cover 24 which is concentric with the aperture 14, such that a front face of the wiper arm 20 is flush with the front face of the annular cover. The annular cover 24 is mounted within a bezel 26 which surrounds the annular cover and the collar, and when the wiper arm 20 is in the stowed position the annular cover 24 is flush with the bezel 26 where the two meet.

The wiper arm may be formed of a single material. However, if required, a wiper blade of a more flexible or resilient material such as an elastomer may be provided as part of the wiper arm, for making contact with and cleaning the exposed surface.

A rear part of the bezel 26 is fixed to a chassis 28. A motor 32 is also mounted to the chassis 28, and is used to drive rotational movement of the collar 30 relative to the chassis 28 about the optical axis 16, which in turn drives movement of the wiper arm 20 between the stowed position shown in FIG. 1 and an active position shown in FIG. 2, and to rotationally wipe the exposed surface of the optical element as the collar rotates.

FIG. 2 shows the apparatus of FIG. 1 when the wiper arm is in the active position, in the process of wiping the exposed surface 11 of the optical element 12, which is shown in this figure. FIG. 2 also illustrates a camera assembly 60 of which the optical element 12 and the exposed surface 11 form a frontal part. In the active position, the wiper arm 22 assumes an essentially radial configuration with respect to the exposed surface 11, instead of the circumferential configuration adopted in the stowed position. The wiper arm in the active position is driven to rotate around the optical element 12 so as to wipe the surface of the optical element 12 before returning to the stowed position.

The wiper arm may move to the active position, rotate fully in one direction about the optical element 12, and return to the stowed position, such that rotation of the wiper arm about the optical element 12 is always in the same direction. Alternatively, rotation in both directions may be used if desired, for example to obtain a different or improved cleaning effect.

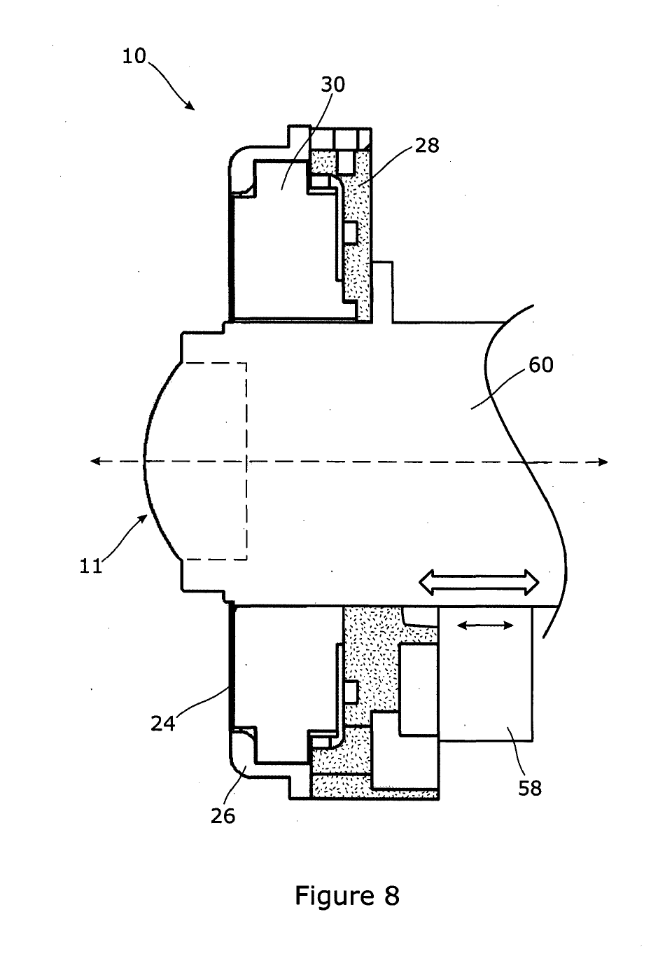

It can be seen from FIG. 2 that the wiper arm is displaced axially in a forward direction between the stowed and active positions. The amount of axial displacement required may vary depending on the position and geometry of the exposed surface 11 to be cleaned. For example, a more convex surface or an exposed surface which needs to be deployed significantly in front of the collar for example for optical reasons may require more forward axial movement between the stowed and active positions. In some cases, it may be that no axial movement is necessary, or it may alternatively or additionally be necessary to provide axial movement of the exposed surface and optical element relative to the apparatus, as described in more detail in connection with FIG. 8.

It can also be seen from FIG. 2 that axial movement of the wiper arm from the stowed position to the active position lifts an end of the annular cover 24 proximal to the wiper arm 20 away from the collar 30 and bezel 26, while an end of the annular cover 24 distal from the wiper arm is fixed relative to the collar 30. As will be seen more clearly in subsequent figures, the annular cover acts in this way as a spring to urge the wiper arm, or components to which the wiper arm is connected, towards the collar 30. To this end, the annular cover may be provided, for example, by a single piece of a springy material such as stainless steel, with a rearward facing tab at the end of the cover distal from the wiper arm. This tab, set approximately at right angles to the front of the annular cover, then couples the annular cover to the collar 30 so that the two co-rotate while allowing lifting of the cover at the end proximal to the wiper arm. Alternative ways of biasing the wiper arm towards the collar may be used, and if no axial movement of the wiper arm between the stowed and deployed positions is needed then the annular cover may be a fixed and/or rigid component.

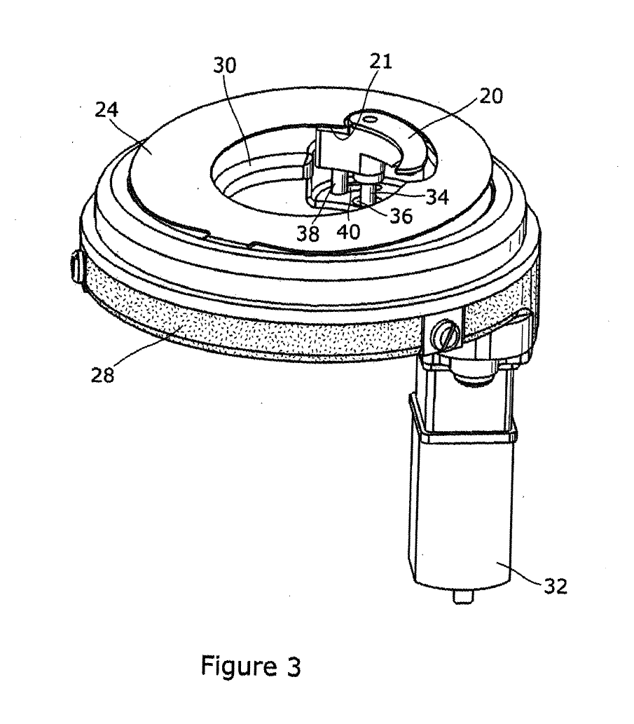

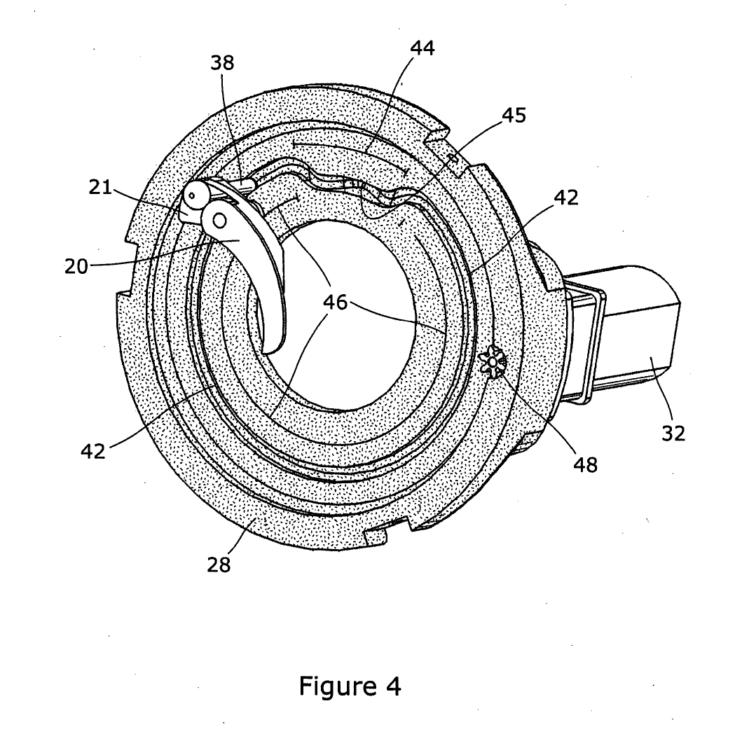

The lifting of the annular cover 24 of FIG. 2 when the wiper arm 20 moves from the stowed to the active position is also shown in FIG. 3, in which the optical element is omitted for clarity purposes. In particular, it can be seen that the wiper arm 20 comprises a shoulder 21 which remains under the annular cover 24 in both positions, and on which the annular cover acts as a spring to urge the shoulder 21 backwards towards the collar 30. It can also be seen from FIG. 3 that the wiper arm 20 is rotationally mounted on the collar 30 using a pin 34 located in a corresponding aperture 36 of the collar 30, which allows both rotation of the wiper arm 20 relative to the collar, and axial displacement between the stowed and active positions. The wiper arm 20 is also provided with a cam follower 38 which in this example is another pin extending from the wiper arm, through an arcuate slot 40 in the collar 30. The cam follower 38 is driven by a cam track, discussed below in connection with FIG. 4.

FIG. 4 shows in perspective view the chassis 28 and the wiper arm 20, with the collar 30 and other components omitted for clarity, so as to show how the cam follower 38 coupled or fixed to the wiper arm 20 is engaged with and arranged to follow the cam track 42. In the present example the cam track 42 is provided by the chassis 28, as a groove in the chassis, into which an end of the cam follower 38 is urged by action of the annular cover acting as a spring. Of course, other configurations of the apparatus in which the cam track is provided in front of or behind the collar 30, and is provided as a raised, recessed or other form of track, with the cam follower obliged to follow the cam track using different mechanisms are possible.

A first portion 44 of the cam track is shaped such that, as the collar 30 rotates relative to the chassis 28, the wiper arm moves between the stowed and active positions, for example by providing suitable variations in depth and lateral offset of the cam track. The remaining second portion 46 of the cam track is shaped such that, as the collar 30 rotates relative to the chassis 28, the wiper arm remains in the active position and rotates about the exposed surface so as to rotationally wipe the exposed surface. In FIG. 4 the second portion follows a curve of constant radius set such that the wiper arm 20 remains in the active, essentially radial position, with a constant depth such that the wiper arm 20 remains axially extended in the active position. Because the second portion of the cam track cannot occupy a full rotation of the collar relative to the chassis, the first and second portions of the cam track should, between them, be arranged to provide rotational cleaning action to substantially the whole of the exposed surface 11. When the wiper arm 20 is fully in the stowed position the cam follower occupies a rest position 45 of the cam track, which in this example is the deepest point of the cam track, in which the wiper arm is not axially extended.

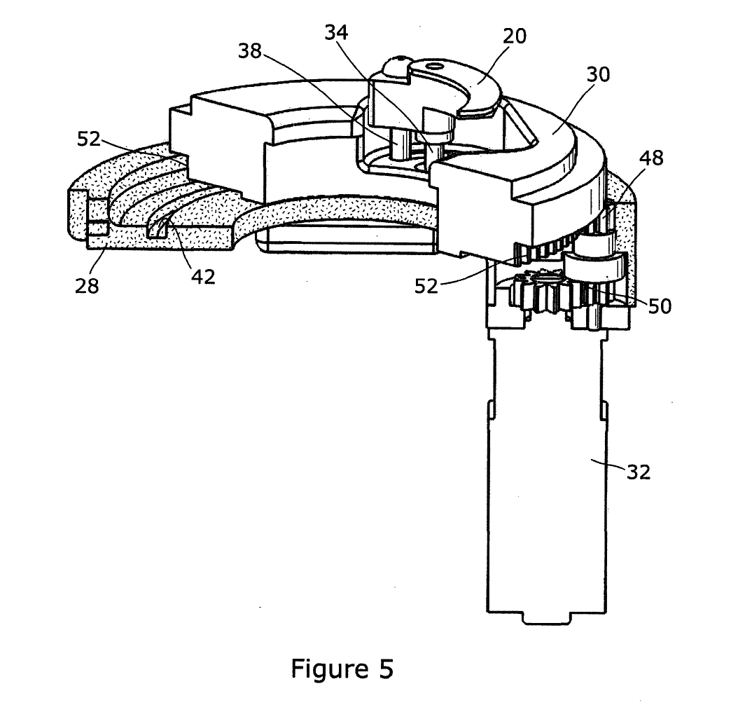

Also shown in FIG. 4 is a pinion 48 mounted for axial rotation in an inward facing surface of the chassis 28 and driven directly or indirectly by the motor 32. This pinion 48 is used to drive rotation of the collar as illustrated in FIG. 5.

FIG. 5 shows, in a cut-away perspective view, the motor 32, collar 30, chassis 28 and wiper arm 20, but omitting the bezel 26. The cam track 42 is visible where the collar 30 has been cut away. The wiper arm is illustrated in a position part way between the stowed and active positions, in which the wiper arm has been axially displaced in a forward direction, but has not yet adopted the radial configuration used for rotational cleaning of the exposed surface.

From this figure it can be seen that the pinion 48 driven by the motor 32 (in this case indirectly through a drive chain 50) drives rotation of the collar 30 through engagement with a toothed rack 52 provided around a circumference of the collar 30. In this way, operation of the motor and corresponding continuous rotation of the pinion 48 in one direction can drive corresponding rotation of the collar 30 relative to the chassis 28 such that the wiper arm moves from the stowed to the active position, rotationally wipes the exposed surface 11, and returns to the stowed position, when operation of the motor ceases pending the next cleaning cycle.

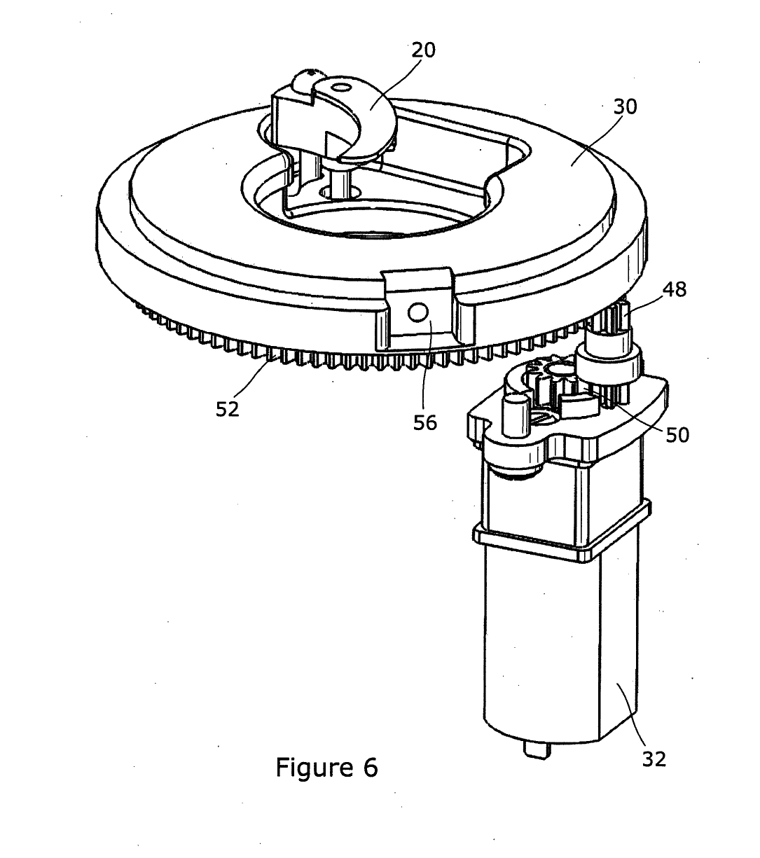

The toothed rack 52 can more clearly be seen in FIG. 6 in which the motor 32, drive chain 50, pinion 48 and collar 30 are shown in perspective view, along with the wiper arm 20 in the active position. Also shown in FIG. 6 is some further detail of the collar. In particular, the external rim of the collar 30 comprises a tab recess 56 arranged to accept the rearward facing tab of the annular cover described above in connection with FIG. 2. The rearward facing tab of the annular cover may be secured in the tab recess 56 by means of a screw or bolt. The tab recess is arranged so that it does not interfere with the full circumferential form of the toothed rack 52.

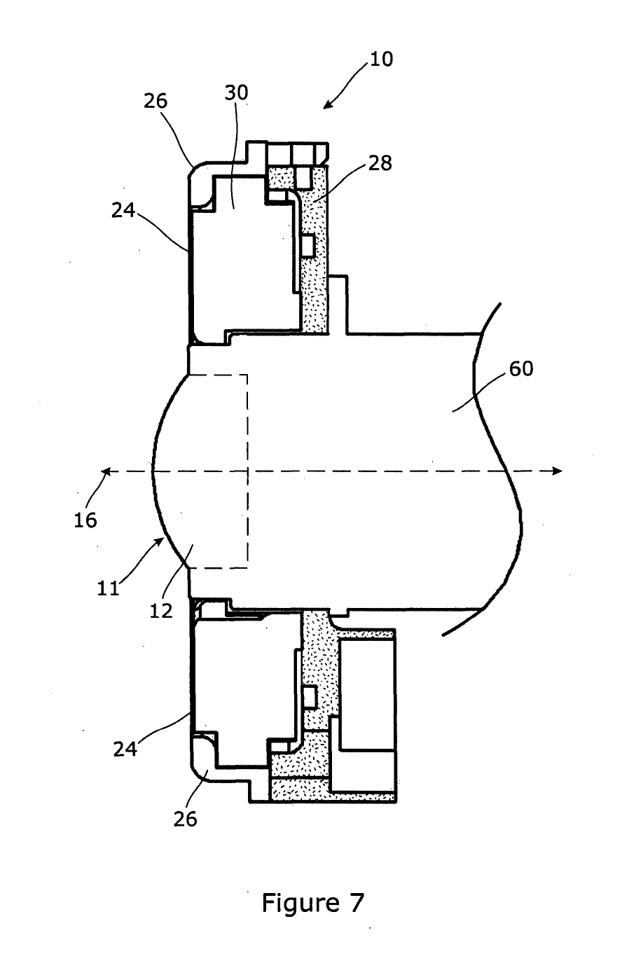

FIG. 7 is a sectional view across the apparatus 10, in which none of the wiper arm 20, motor 32, drive chain 50, pinion 48 or annular cover tab are seen. This figure also shows in cross section a camera assembly 60 mounted in the apparatus 10, the camera assembly 60 incorporating the optical element 12 with exposed surface 11. Whether the optical element 12 is part of a camera assembly, or is used for some other purpose, the apparatus 10 is particularly advantageous when the exposed surface 11 is a convex surface, for example a spherical or other rotationally symmetrical and/or convex surface of a wide angle lens. In this figure the optical element is shown as being of similar depth in the axial direction to the collar, and resides largely within the collar, but the optical element could be deeper or shallower in the axial direction, and could for example be relatively thin and reside forwards of the collar in an axial direction.

Details the wiper arm 20 and its movement between the stowed and active positions may be dependent, for example, on the degree of curvature of the exposed surface and its position relative to the apparatus. For example, an exposed surface 11 with a higher degree of curvature and deeper profile in the axial direction may require a larger axial movement of the wiper arm between the stowed and active positions.

In some situations it may be desirable for the optical element 12 to be situated sufficiently far forward in the apparatus, or to have such a high degree of convex curvature, that it is impractical for axial movement of the wiper arm alone to bring the wiper arm into a suitable deployed position for cleaning the exposed surface 11. Such a situation may arise, for example, if a very wide angle lens is being used, for example having a field of view of more than 160 degrees, or even more than 180 degrees. In such situations, the apparatus 10 may be equipped with an axial drive 58 arranged to move the relative axial positions of the optical element 12 and the apparatus 10 or some particular part of the apparatus 10 such as the chassis 28.

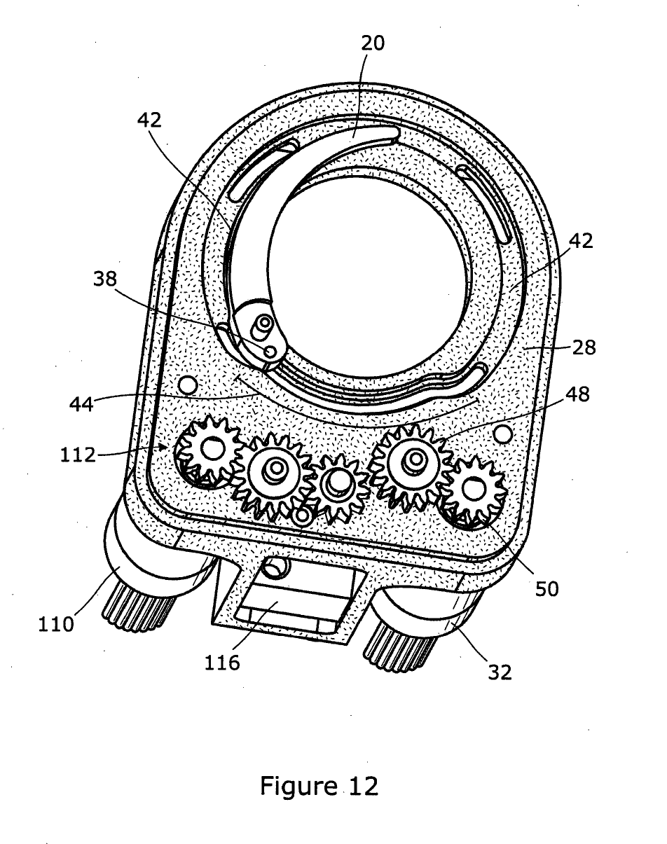

This is illustrated in FIG. 8 which shows a camera assembly 60 coupled to the apparatus 10 in such a manner that the camera assembly 60 including the optical element 12 can be retracted axially within the apparatus 10 in order to bring the exposed surface 11 into suitable positions for optical deployment and for cleaning by the wiper arm. The axial drive 58 is shown in FIG. 8 in a highly schematic form, and in practice may be implemented in a number of ways, for example being driven by a cam arrangement coupled to the motor 32 already being used for rotation of the collar 30 relative to the chassis 28, or using an axial drive motor as discussed below in connection with FIGS. 12 to 16.

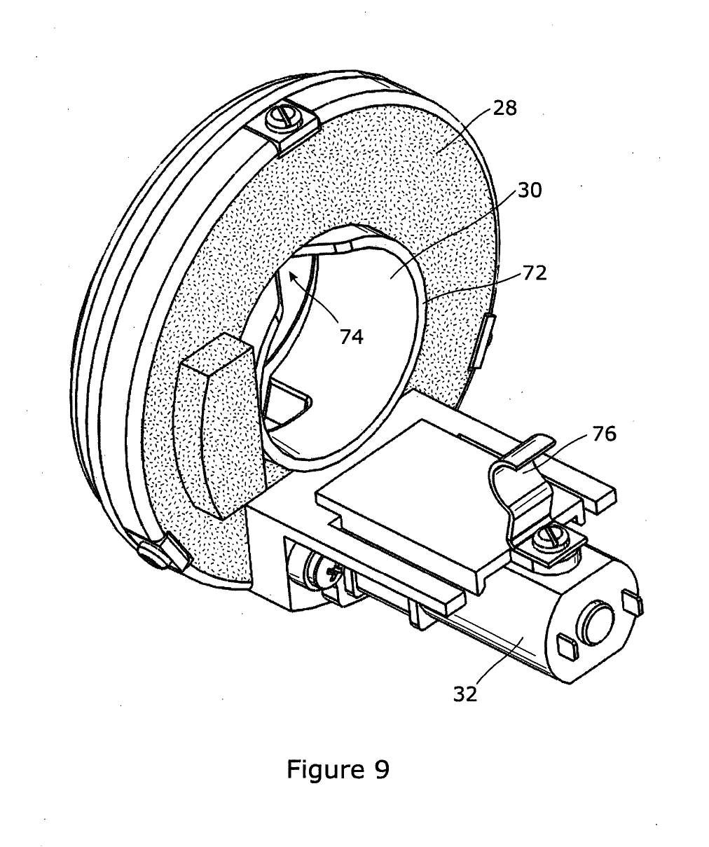

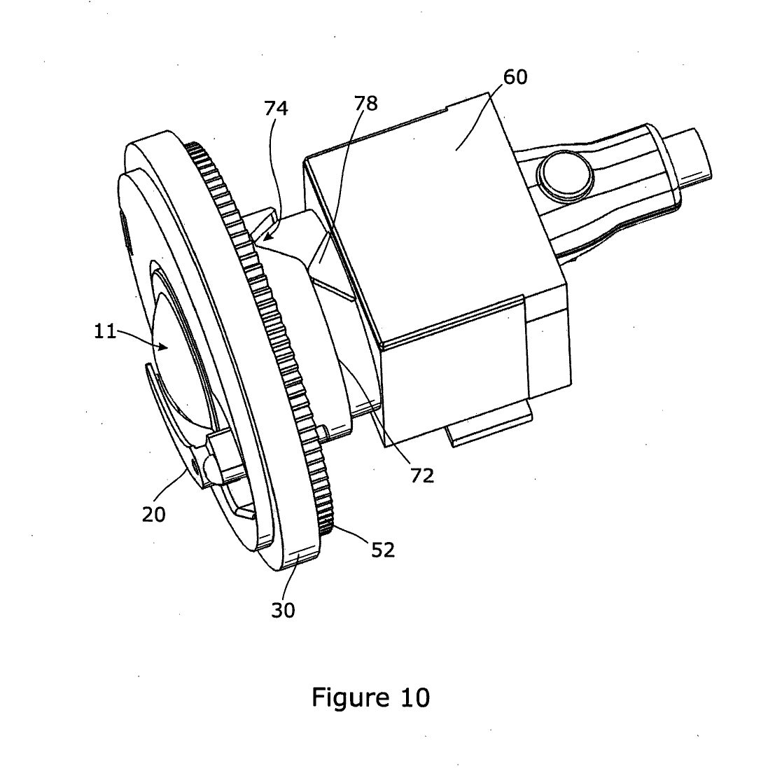

FIG. 9 shows an example implementation of axial drive 58 in which an inner rim 72 of the collar 30 acts as a circular cam, as it rotates driven by the motor 32 relative to the chassis 28. In particular, a notch 74 in the rim 72 is arranged to allow the camera (not shown in this figure) to move forward to an operational position in which the front surface of the camera lens protrudes as shown in FIG. 10, when the cleaning action of the apparatus 10 is not in operation. This is at the same time as the wiper arm 20 is fully in the stowed position and the cam follower 38 of the wiper arm occupies the rest position 45 of the wiper arm cam track shown in FIG. 4. As also shown in FIG. 9, a camera spring 76 urges the camera, mounted to slide or be otherwise moveable axially, towards the rim 72. As the collar rotates to move the wiper arm from the stowed to the active position, rotation of the rim urges the camera, through a camera cam follower mounted to the camera, away from the collar 30 and towards the camera spring. As the cleaning action comes to an end, the camera spring 76 again moves the camera 60 back towards the collar as the camera cam follower moves back into the notch 74.

This action can be better understood from the perspective view of FIG. 10 which for clarity omits the chassis 28, motor 32 and bezel 26, but shows the camera cam follower 78 following the camming action of the rim 72 and notch 74 as the collar 20 rotates to also effect the cleaning movement of the wiper arm 20.

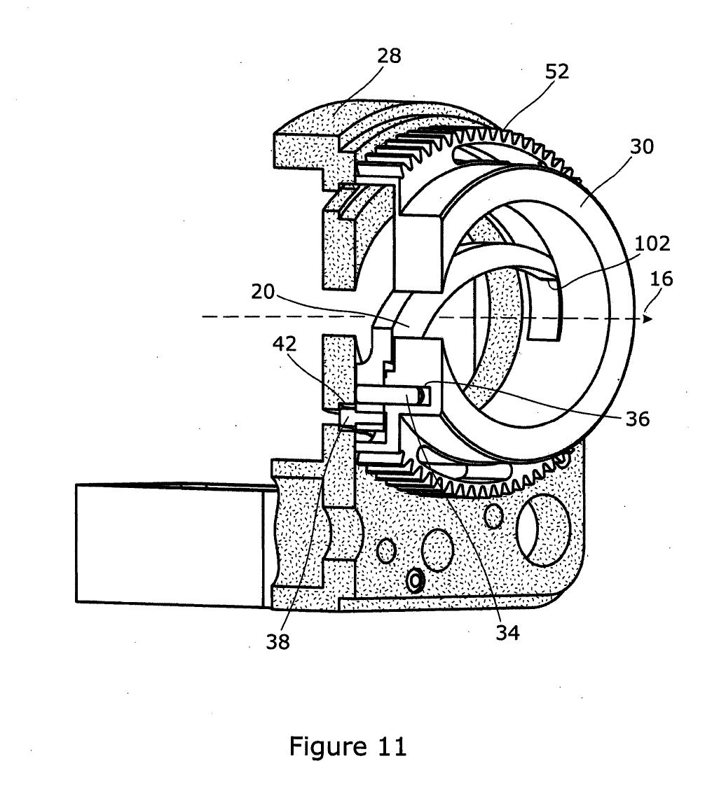

Referring to FIG. 11 there is illustrated in perspective, cut away and partial view a second embodiment of the invention. In particular, this FIG. illustrates how the arrangements discussed with reference to FIGS. 1 to 10 can be modified in certain ways, and to this end some of the components which have corresponding functions are labelled with the same reference numerals.

The arrangement of FIG. 11 shows the wiper arm 20 mounted between the chassis 28 and the collar 30, instead of in front of the collar as shown in earlier figures. However, as shown in the earlier figures, the wiper arm 20 is rotationally mounted on the collar by a pin 34, and is driven to rotate by a cam follower 38 which follows a track 42 provided by the chassis 28. The collar 30 is driven to rotate about an optical axis 16 of the optical element (not shown in this figure) by means of a toothed rack 52 provided around the circumference of the collar 30 and a geared driving mechanism shown in FIG. 12.

In FIG. 11 the wiper arm 20 is shown in a partially deployed position, midway between a stowed position in between the collar and the chassis, and a deployed position in which the wiper arm is disposed approximately diametrically across the exposed surface of the optical element (not shown in this figure). Compared with the arrangement of FIGS. 1 to 10, the wiper arm 20 of FIG. 11 is rather longer, so that when in the deployed position it reaches substantially or fully across the width or diameter of the optical element. A tip 102 of the wiper arm may be retained within a groove, for example a groove of the collar, or behind the collar, when in the deployed position (and optionally also when in the stowed position and all positions in between deployed and stowed) to thereby resist pressure applied to the wiper arm by the optical element when wiping the exposed surface, and provide an improved and firmer contact between the wiper arm and the exposed optical surface and/or enable a less rigid wiper arm 20 to be used.

FIG. 12 shows how the wiper arm 20 may be disposed relative to the chassis 28 in the arrangement of FIG. 11, and how the cam follower 38 is then disposed relative to the cam track 42. Note that the cam track 42 deviates in from a circular form in a radial direction relative to the optical axis over a first portion 44 of the cam track, in order to drive the wiper arm from a stowed position to a deployed position, and then back again when the wiping action is complete. Note also, however, that in this arrangement the cam track does not deviate in an axial direction, so that the wiper arm is not driven in an axial direction but instead remains in a single plane for the whole of its movement. The slots in the chassis adjacent to the cam track are for the purposes of allowing water and dirt to egress, and do not have any role in driving the cam follower.

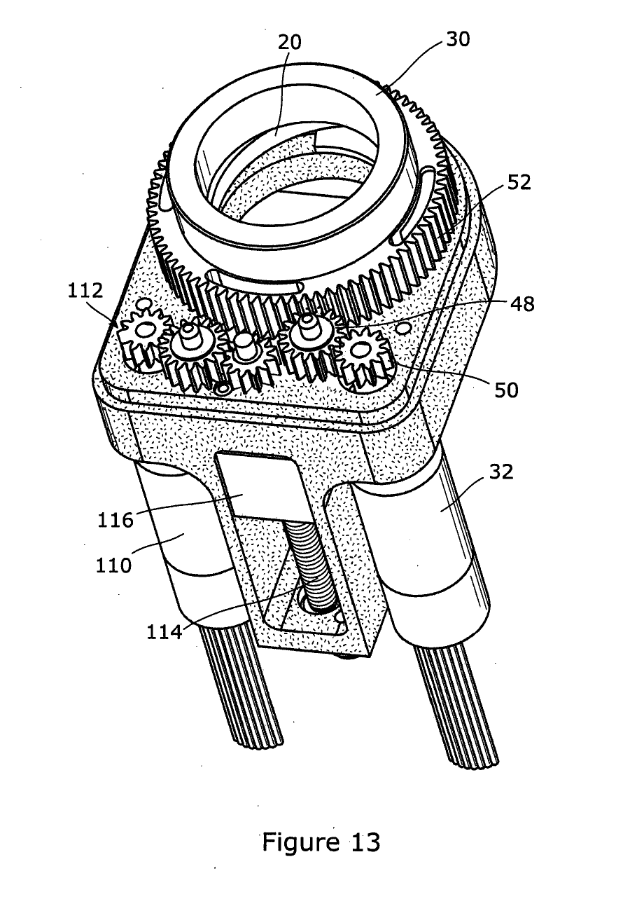

FIG. 12 also shows the pinion 48 which drives the rotation of the collar 30, and which is itself driven by wiper motor 32 through drive train 50. This is also illustrated in FIG. 13 in which the collar is also shown.

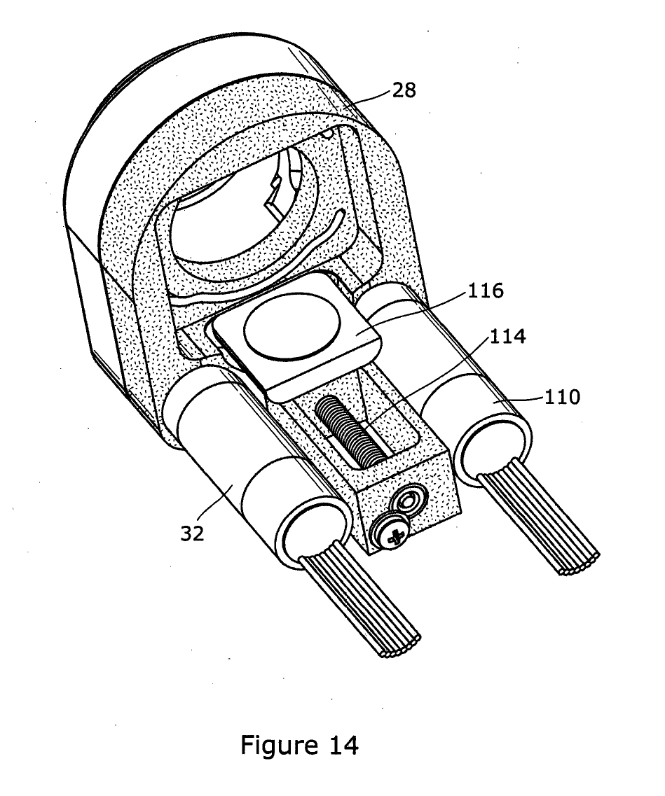

As already discussed in connection with FIGS. 8-10, the optical element may be retracted by an axial drive 58 which can take various forms. In FIGS. 12, 13 and 14 the axial drive is provided by an axial drive motor 110. FIGS. 12 and 13 show a retraction motor drive train 112 which couples rotational motion of the axial drive motor 110 to a lead screw 114 (omitted in FIG. 12). As more clearly seen in FIG. 14, carriage 116 is driven axially by rotation of the lead screw 114. The optical element is carried, directly or indirectly, on the carriage so that it can be driven axially in a forward and backward direction by action of the axial drive motor 110. Typically, a camera assembly 60 (not shown in FIGS. 12-14) may be mounted on the carriage 116, and the optical element will be a part of that camera assembly. Of course, the axial drive 58 may be implemented in a variety of other ways using an axial drive motor 110.

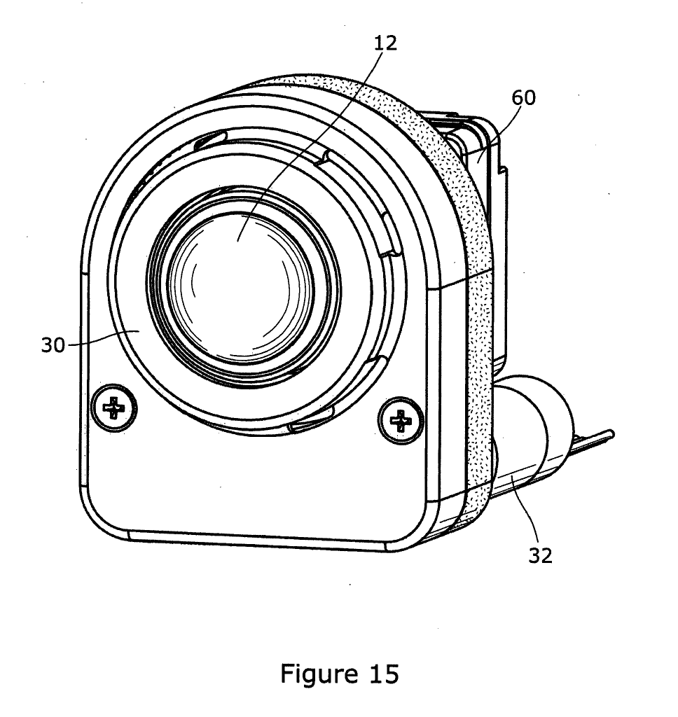

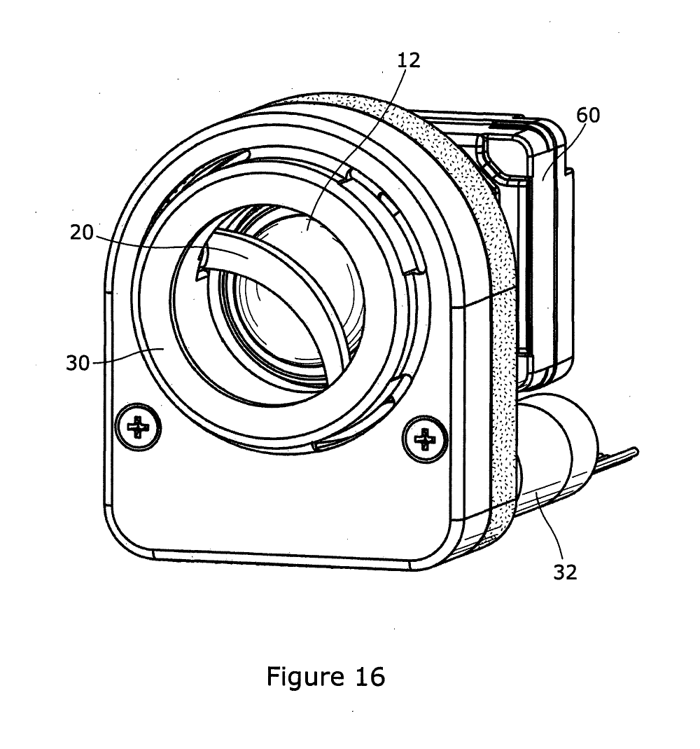

FIGS. 15 and 16 are front perspective views of the mechanism of FIGS. 11 to 14 implemented to axially move a camera assembly 60 and to clean an exposed optical surface 12 of that camera assembly 60 using the wiper arm 20. In FIG. 15 the optical surface is in an axially extended position, for example where at least a part of the optical surface 12 extends beyond the collar 30, including any bezel or similar covering provided on the collar. If the optical surface 12 is the surface of a wide angle lens, in this position an improved viewing angle may be provide for the lens because of reduced or avoided interference in the view of the lens by the collar 30 and any bezel or similar.

In operation, the axial drive 58 is used to retract the optical surface 12, for example by retracting the camera assembly 60 using the mechanism discussed in connection with FIGS. 12-14, or some other mechanism, to a retracted position as shown in FIG. 16. Once retracted, the wiper motor 32 may be used to drive the mechanism discussed in connection with FIGS. 11-13, or some other mechanism in order to deploy the wiper blade, carry out a rotational cleaning action, and then to stow the wiper blade. FIG. 16 shows the wiper blade 20 in a deployed position during the rotational cleaning action.

An axial drive 58 using a motor, for example an electrical motor to drive the axial movement of the exposed optical surface may be advantageous in a variety of ways. For example, it will be noted that the rotational cleaning mechanism of FIGS. 11-13 lacks the axial deployment movement of the wiper blade evident in the mechanism of FIGS. 1-6, and in FIGS. 11-13 this is replaced by a suitable range of movement and control of the axial drive 58, thereby simplifying the cam track based mechanism, and allowing more of the cam track and range of rotational movement to be used in the cleaning operation.

An axial drive 58 using a motor may also be used to provide further cleaning action movement, for example by providing small axial movements of the optical surface 12 when the wiper blade is in a deployed position, and optionally while the wiper blade also is rotating. For example, a small oscillatory axial movement could be used for this purpose. Such an axial movement during the cleaning action could be used to provide a more thorough or intense cleaning action, and could be employed as part of every or most cleaning actions, or less frequently for example when the normal cleaning action has not provided a satisfactory result (this could be detected automatically using the camera assembly and suitable data processing).

More generally, axially movement can be controlled in different ways for various purposes, including at different axial speeds, in either direction, to different positions of extension and retraction, and at chosen frequencies and times. The optical element can therefore be retracted and extended for different purposes, for example being retracted to keep cleaner, for reasons of security, and/or protection from damage in other ways, when not in use or when necessary or desirable for such purposes.

The increased amount of axial movement afforded by a motorised axial drive 58 may also be used to enable additional extension in an axial direction. This could be used so that the mechanisms required for cleaning the exposed optical surface can be concealed behind a panel through which the optical surface is extended. An increased amount of axial movement could also be used to provide an even wider viewing angle, for example for a wide angle lens, by providing further extension out of a body panel or similar.

Increasing the amount of axial movement afforded by a motorised axial drive 58 may also allow the mechanisms required to implement the wiper blade to be more compact diametrically, thereby allowing it to fit within more confined spaces. This could be useful in situations where space is very limited for example when the optical element is to be fitted within an automobile overtaking mirror or similar.

Although particular detailed embodiments of the invention have been described, it will be apparent that a variety of variations and modifications may be carried out without departing from the scope of the invention.

1. Apparatus for cleaning an exposed surface of an optical element, the apparatus comprising:
a collar arranged to be disposed circumferentially around, and to rotate around, an axis of an optical element which the apparatus is arranged to clean; and
a wiper arm coupled to the collar so as to rotationally clean the exposed surface of the optical element as the collar rotates.

2. The apparatus of claim 1 wherein the wiper arm is arranged to move, relative to the collar, between a stowed position, and an active position in which the exposed surface of the optical element may be cleaned by the wiper arm.

3. The apparatus of claim 2 wherein the wiper arm is rotationally coupled to the collar for movement between the stowed and active positions across the exposed surface.

4. The apparatus of claim 3 wherein the wiper arm is also coupled to the collar so as to move axially relative to the optical element between the stowed and active positions.

5. The apparatus of any of claims 2 to 4 arranged such that rotation of the collar around the optical axis drives the wiper arm between the stowed and active positions.

6. The apparatus of any of claims 2 to 5 further comprising a cam track, wherein the wiper arm is coupled to a cam follower arranged to follow the cam track as the collar rotates so as to move the wiper arm between the stowed and active positions.

7. The apparatus of claim 6 wherein the cam track comprises a first portion which drives the wiper arm between the stowed and active positions, and a second portion which retains the wiper arm in the active position for wiping the exposed surface as the collar rotates.

8. The apparatus of claim 7 wherein the cam track forms a continuous loop so that on rotation in a single direction the wiper arm moves from the stowed position to the active position, wipes the exposed surface, and returns from the active position to the stowed position.

9. The apparatus of any of claims 6 to 8 wherein the collar is disposed adjacent to and arranged to rotate relative to a chassis, and the cam track is comprised in the chassis.

10. The apparatus of any of preceding claim further comprising an annular cover disposed in front of the collar.

11. The apparatus of any of claims 6 to 9 further comprising an annular cover disposed in front of the collar, wherein the annular cover is sprung so as to bias the cam follower towards the cam track.

12. The apparatus of claim 11 arranged such that one end of the annular cover is fixed relative to the collar, and the other end of the annular cover is urged away from the collar by the axial movement of the wiper arm from the stowed to the active position.

13. The apparatus of claim 9 wherein the wiper arm is mounted between the chassis and the collar.

14. The apparatus of claim 13 wherein a distal portion of the wiper arm is retained within a groove of the collar in one or both of the stowed and active positions.

15. The apparatus of any preceding claim further comprising a motor arranged to rotate the collar around the axis of the optical element.

16. The apparatus of any preceding claim wherein the wiper arm comprises a wiper blade arranged to contact the exposed surface, wherein the wiper blade is formed from a flexible material.

17. The apparatus of any preceding claim wherein the optical element is a camera lens.

18. The apparatus of any preceding claim wherein the exposed surface is a transparent convex surface.

19. The apparatus of any preceding claim wherein the exposed surface is a convex surface with a rotationally symmetric curvature.

20. The apparatus of any preceding claim wherein the optical element is a wide angle lens and the exposed surface is a convex exposed optical surface of the wide angle lens

21. The apparatus of any preceding claim wherein the exposed surface is deployed for use of the optical element at least partly in front of the collar.

22. The apparatus of any preceding claim further comprising an axial drive arranged to retract the exposed surface from the position in which it is deployed for use.

23. The apparatus of claim 22 wherein the axial drive is arranged to retract the exposed surface for the rotational cleaning of the exposed surface of the optical element as the collar rotates, and to axially extend the optical element forwards again after cleaning.

24. the apparatus of claim 22 wherein the axial drive is arranged to retract the exposed surface for protection of the exposed surface of the optical element.

25. The apparatus of claim 22 or 23 wherein the axial drive comprises a circular cam arranged to co-rotate with the collar, the circular cam being provided with a recess arranged to urge axial retraction of the optical element before cleaning, and to allow forwards axial extension of the optical element after cleaning.

26. The apparatus of any of claims 22 to 24 wherein the axial drive comprises an axial drive motor arranged to retract and extent the exposed surface.

27. The apparatus of claim 26 wherein arranged to use the axial drive to move the exposed surface axially during the rotational cleaning of the exposed surface to thereby improve the cleaning effect.

28. The apparatus of any preceding claim further comprising said optical element.

29. A vehicle comprising a camera having a wide angle lens, and the apparatus of any of claims 1 to 28 arranged to automatically clean an exposed optical surface of the wide angle lens.

30. Apparatus for cleaning an exposed surface of an optical element, comprising:
an axial drive arranged to retract the exposed surface towards the apparatus to a retracted position and to extend the exposed surface away from the apparatus to a deployed position; and
a wiper arm arranged to rotationally clean the exposed surface.

31. The apparatus of claim 30 wherein the wiper arm is arranged to rotationally clean the exposed surface when in the retracted position.

32. The apparatus of claim 30 or 31, further comprising a cam arranged to co-rotate with the wiper arm, the cam being provided with a shape arranged to urge axial retraction of the optical element before cleaning and to allow forwards axial extension of the optical element after cleaning.

33. The apparatus of claim 32 wherein the cam is provided by a rim of a collar arranged to be disposed circumferentially around, and to rotate around, an axis of the optical element which the apparatus is arranged to clean, the wiper arm being coupled to the collar so as to rotationally clean the exposed surface of the optical element as the collar rotates.

34. The apparatus of claim 30 or 31, wherein the axial drive comprises an axial drive motor arranged to drive the exposed surface between the deployed and retracted positions.

35. The apparatus of any of claims 30 to 34 further comprising the features of any of claims 1 to 29.

36. A method of cleaning an exposed convex surface of an optical element comprising: disposing a wiper arm radially on the exposed surface; and rotating a circumferential end of the wiper arm around the outside of the exposed surface.

37. The method of claim 36 further comprising rotating the wiper arm to a circumferentially stowed position after cleaning the exposed convex surface.

38. The method of claim 36 or 37 wherein the exposed convex surface is a rotationally symmetric transparent convex surface.
